(19) United States
(12) Patent Application Publication
(10) Pub. No.: US 2017/0355625 A1
(43) Pub. Date: Dec. 14, 2017

(54) ELECTROLYSIS APPARATUS FOR WATER STERILIZATION AND PIPE CLEANING

(71) Applicant: Si Chun PARK, Incheon (KR)

(72) Inventor: Si Chun PARK, Incheon (KR)

(21) Appl. No.: 15/523,989

(22) PCT Filed: Nov. 9, 2015
(86) PCT No.: PCT/KR2015/011985

§ 371 Date: May 3, 2017

(30) Foreign Application Priority Data
Nov. 10, 2014 (KR) 10-2014-0155665

(51) Int. Cl. C02F 1/467; B08B 9/032

(52) U.S. Cl. CPC C02F 1/4674; B08B 9/0321; C02F 2303/04; C02F 2201/46155; C02F 2201/4611

(57) ABSTRACT

The invention is an electrolysis apparatus for water sterilization and pipe cleaning, and comprises: a pipe 100 having a forward flowing portion 110, a backward flowing portion 120; an electrolyzing chamber 200 positioned between the forward flowing portion 110 and the backward flowing portion 120 of the pipe 100 with an electrolyte inlet 210 and an outlet 220 communicating with the forward flowing portion 110 or the backward flowing portion 120 to let the products generated from the electrolysis reaction exhaust into the forward flowing portion 110 or the backward flowing portion 120; and +, − electrodes 300 installed in the electrolyzing chamber 200.

### TECHNICAL FIELD

The present invention relates to an electrolysis apparatus for water sterilization and pipe cleaning, and more particularly to an electrolysis apparatus which has high electrolyzing efficiency, so it could achieve high effects of water sterilization and pipe cleaning with compact structure.

### BACKGROUND ART

Usually, in swimming pools or facilities using water, electrolysis method is used for sterilizing water and cleaning pipe line used to supply the water. For this, an electrolysis apparatus is coupled to the pipe line, and electrolyte is added to the supplied water and electrolysis reaction is implemented. Then, the water is electrolyzed and sterilized, and the slurry attached on the inner surface of the pipe is ionized and removed by the oxidative and reductive electrolytes generated by the water electrolysis, which results in pipe cleaning.

To enhance the electrolysis efficiency, the treated water should sufficiently contact electrodes of the electrolysis apparatus. But, in the conventional electrolysis apparatus, the treated water rapidly flows into and flows out of the electrolysis tank, so the treated water could not sufficiently contact the electrodes of the electrolysis apparatus. Accordingly high efficiency of electrolysis could not be expected.

In addition, to enhance the electrolysis efficiency, high current should be applied to the electrodes of the electrolysis apparatus, which result in the overheating of the electrodes, so the duration of the electrodes is reduced. Therefore, the means to prevent the overheating of the electrodes is required.

### DISCLOSURE

### Technical Problem

The present invention is proposed to solve the above problems, and the object of the invention is to provide a new electrolysis apparatus which has high electrolyzing efficiency, so it could achieve high effects of water sterilization and pipe cleaning with compact structure.

### Technical Solution

According to an aspect of the present invention, there is provided an electrolysis apparatus for water sterilization and pipe cleaning, wherein the apparatus comprises:

a pipe 100 with U or S shape which has a forward flowing portion 110, a backward flowing portion 120 whose base end is connected to the forward flowing portion 110 and whose fore end is positioned separately apart from the forward flowing portion 110 so that the treated water can flow backwardly against the direction of the treated water flowing in the forward flowing portion 110;

an electrolyzing chamber 200 positioned between the forward flowing portion 110 and the backward flowing portion 120 of the pipe 100, and having an electrolyte inlet 210 and an outlet 220 communicating with the forward flowing portion 110 or the backward flowing portion 120 to let the products generated from the electrolysis reaction exhaust into the forward flowing portion 110 or the backward flowing portion 120; and

+, − electrodes 300 installed in the electrolyzing chamber 200.

According to another aspect of the present invention, there is provided an electrolysis apparatus, wherein the +, − electrodes 300 have inserts 302 extending into the forward flowing portion 110 and the backward flowing portion 120.

According to another aspect of the present invention, there is provided an electrolysis apparatus, wherein the + electrode 300 and the − electrode 300 are positioned on the opposite side of the electrolyzing chamber 200,400 respectively.

According to another aspect of the present invention, there is provided an electrolysis apparatus, wherein a second forward flowing portion 130 is connected to the backward flowing portion 120, in which the treated water flow in the same direction with the treated water in the forward flowing portion 110, and a second electrolyzing chamber 400 is provided between the backward flowing portion 120 and the second forward flowing portion 130.

### Advantageous Effects

According to the present invention, as the treated water flows in the bent pipe 100, the flow speed of the treated water may be reduced, so that the treated water can contact the electrodes 300 sufficiently, and the electrolysis efficiency will be enhanced.

In addition, as the electrolyzing chamber 200 is formed between the forward flow portion 110 and the backward flow portion 120, the overall structure of the apparatus may be compact, so it can be installed in narrow space.

And, as the electrodes 300 installed in the electrolyzing chamber 200 have inserts 302 extending into the forward flowing portion 110 and the backward flowing portion 120, electrolysis reaction may be generated in the pipe 100 additionally, so the efficiency of electrolysis reaction may be further increased.

And, as the inserts 302 of the electrodes 300 contact the treated water, the +, − electrodes 200 can be cooled, so the damage of the electrodes 300 due to overheating can be prevented.

And, as the +, − electrodes 300 are positioned on the opposite side of the electrolyzing chamber 200 respectively, the current may be applied on the overall electrodes 300 uniformly, so the efficiency of the electrolysis may be enhanced.

As mentioned above, as the efficiency of electrolysis reaction of the present invention is high, if the invention is used in the pipe line of the swimming pool and other various facilities, the water and the pipe line can be effectively sterilized and cleaned, so the hygienic management of the water and the pipe line can be achieved.

### DESCRIPTION OF THE DRAWINGS

FIG. 1 is a perspective view of the first embodiment of the present invention

FIG. 2 is a side section of the above embodiment

FIG. 3 is a section according to line A-A of FIG. 1

FIG. 4 is a section in used state of the above embodiment

FIG. 5 is a section of the second embodiment of the present invention

FIG. 6 is a view showing the path of the current flow

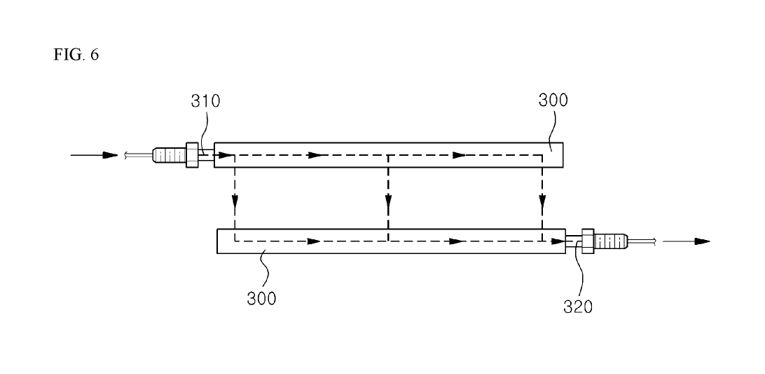

### DETAILED DESCRIPTION OF THE INVENTION

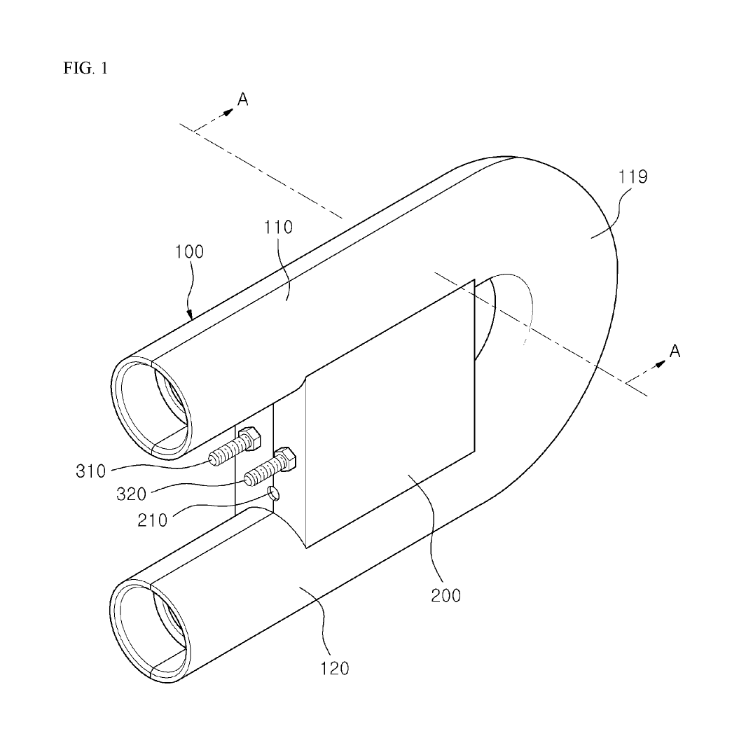

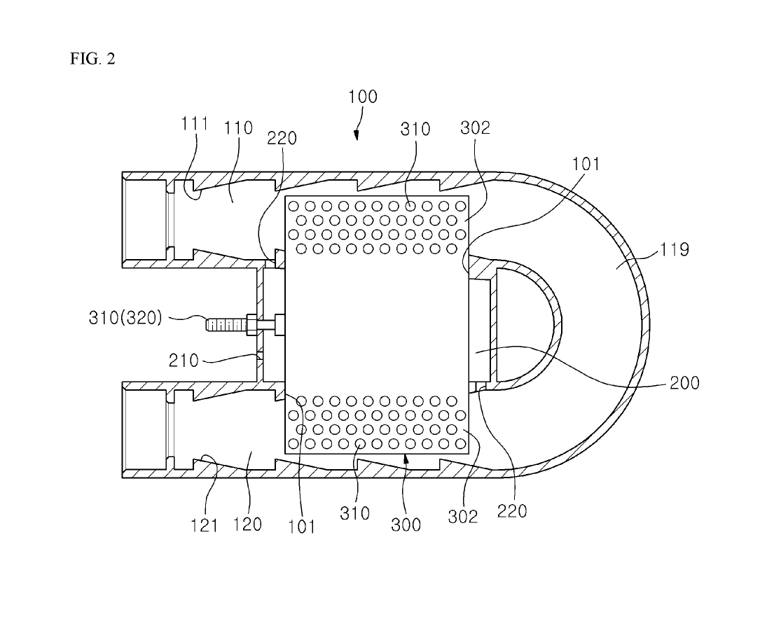

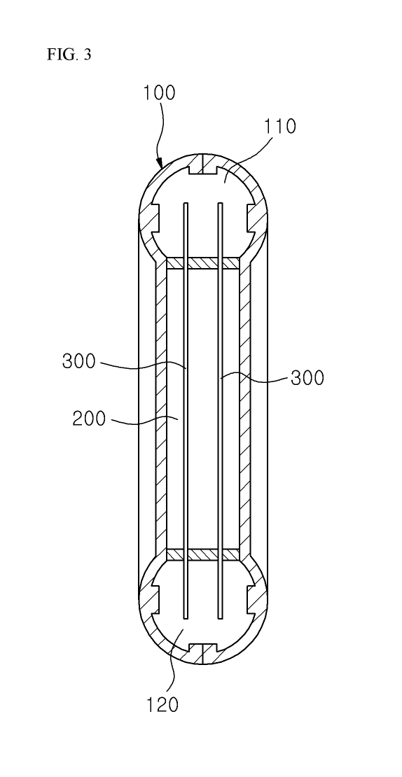

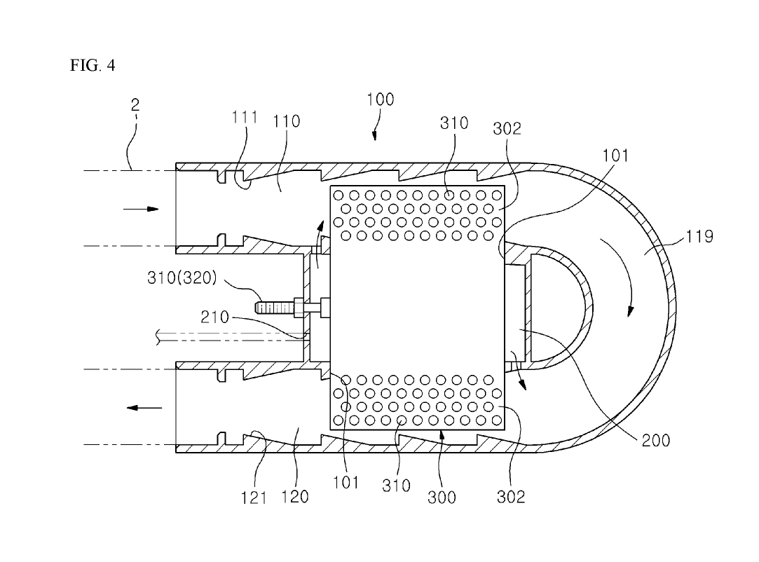

Hereinafter, the preferred embodiments of the invention will be described with reference to the drawings. FIG. 1 to FIG. 3 are a perspective view and sections of the first embodiment of the invention, and FIG. 4 is a section in used state. As shown in the drawings, the invention includes a pipe 100 in which the treated water flows, an electrolyzing chamber 200 formed in the space partitioned by the pipe 100, and +, − electrodes 300 installed in the electrolyzing chamber 200.

The pipe 100 has a U shape and includes a forward flowing portion 110 in which the treated water flows forwardly and a backward flowing portion 120 connected to the forward flowing portion 110 and in which the treated water flows backwardly against the water direction in the forward flowing portion 110. The backward flowing portion 120 connected to the forward flowing portion 110 by the bent portion 119 formed at the fore end of the forward flowing portion 110 is positioned separately apart from the forward flowing portion 110.

Therefore, the treated water flowing into the pipe 100 can flow through the U shape bent flow path formed by the forward flowing portion 110 and the backward flowing portion 120. Agitating projections 111, 121 are formed in the inner wall of the pipe 100 to agitate and mix the water with the products generated by the electrolysis reaction as mentioned in the following.

An electrolyzing chamber 200 is formed between the forward flowing portion 110 and the backward flowing portion 120 of the pipe 100. The electrolyzing chamber 200 has an electrolyte inlet 210 through which electrolyte is introduced from outside, and an outlet 220 communicating with the forward flowing portion 110 or the backward flowing portion 120 to let the products generated from the electrolysis reaction exhaust.

+, − electrodes 300 are installed in the electrolyzing chamber 200. The +, − electrodes 300 are made of rectangular plates and they are positioned faced to each other. The electrodes 300 have inserts 302 on the upper and lower ends extending into the forward flowing portion 110 and the backward flowing portions 120. For this, openings 101 are formed between the electrolyzing chamber 200 and the forward flowing portion 110 and between the electrolyzing chamber 200 and the backward flowing portion 120 respectively. The inserts 302 of the electrodes 300 are inserted in these openings 101 and extend into the forward flowing portion 110 and the backward flowing portion 120.

A plurality of pores 310 are formed on the electrodes 300, which may enhance flowing of the treated water or mixing of the treated water with the electrolyte near the electrodes 300 to increase the efficiency of electrolysis reaction. The electrodes 300 have connecting terminals 320, 330 to connect the outer electric power lines.

Preferably, the pipe 100 and the electrolyzing chamber 200 are formed in one body with the plastic material though the injection molding process. Preferably, the body of the invention consisting of the pipe 100 and the electrolyzing chamber 200 is made of two divided parts in consideration of easily assembling.

Hereinafter, the operation of the present invention will be described.

In the exemplary embodiment of the present invention, weak hydrochloric acid is used for electrolyte. The pipe 100 is connected to supply lines 2 from which the treated water is supplied. Accordingly, the treated water is introduced from the forward flowing portion 110 of the pipe 100 and flows out though the backward flowing portion 120 of the pipe 100. And weak hydrochloric acid as electrolyte is injected through the electrolyte inlet 210 into the electrolyzing chamber 200.

When the current is applied to the +, − electrodes 300, the weak hydrochloric acid is electrolyzed and chlorine gas is produced, The produced chlorine gas is introduced through outlet 220 into the forward flowing portion 110 and the backward flowing portion 120, and the chlorine gas is dissolved in the treated water to produce hypochlorous acid, and eventually hypochlorous acid water.

The above reaction is shown in the formula below.

2HCl+H₂O→HOCl+HCl+H₂

This time, other materials also be produced and these materials will be exhausted through the outlet 220 together with the chlorine gas.

Meanwhile, hydrochloric acid is also generated during the above reaction of generating hypochlorous acid from chlorine gas, and the generated hydrochloric acid will be electrolyzed by the inserts 302 of the electrodes 300 projecting into the forward flowing portion 110 and the backward flowing portion 120 of the pipe 100 to produce hypochlorous acid additionally.

As described above, as the weak hydrochloric acid as electrolyte is electrolyzed, the hypochlorous acid is produced, then the treated water may be sterilized by the hypochlorous acid and the inside of the pipe line 2 will also be sterilized and cleaned by the hypochlorous acid.

Particularly, as the pipe 100 is formed in the bent form of U shape, the flow speed of the treated water in the pipe 100 may be relatively reduced, so the treated water can contact the inner surface of the pipe 100 sufficiently, which will result in the enhanced efficiency of electrolysis reaction. And, as mentioned above, the additional electrolysis reaction may be carried out in the pipe 100, so the efficiency of electrolysis is additionally enhanced.

And, as the inserts 302 of the electrodes 300 contact the treated water flowing in the pipe 100, so they can be cooled by the treated water, so the damage of the electrodes 300 due to the heating can be effectively prevented.

Until now, the present invention is described as it uses weak hydrochloric acid as electrolyte. But other material such a NaCl or NaOCl can be used. If NaCl is used to be electrolyzed, sodium hypochlorite will be produced, and if the sodium hypochlorite is electrolyzed, ClO₃⁻ will be produced.

In the above embodiment, a pair of electrodes 300 is provided in the electrolysis apparatus. But plural pairs of electrodes can be provided in the apparatus.

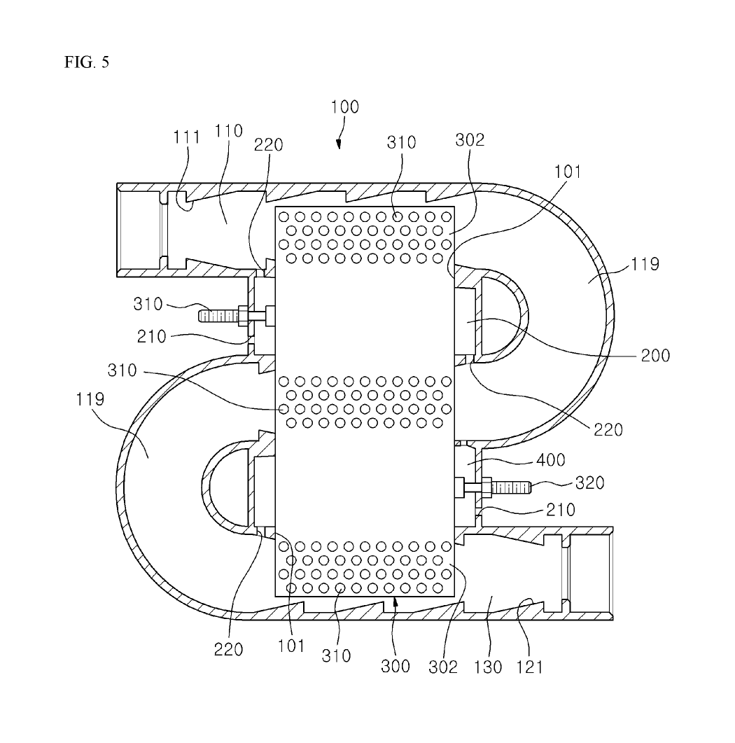

The other embodiment of the invention will be described in reference with FIG. 5, and the description about the same components with those of the first embodiment will be omitted.

The pipe 100 of this embodiment is formed of S shape, and the second forward flowing portion 130 is connected to the backward flowing portion 120. As shown in FIG. 5, a bent portion 119 is further connected to the fore end of the backward flowing portion 120, and the second forward flowing portion 130 is connected to the other end of the bent portion 119. As the forward flowing portion 110 and the second flowing portion 130 are provided on both side of the backward flowing portion 120, the electrolyzing chamber 200 is to be formed between the forward flowing portion 110 and the backward flowing portion 120, and the second electrolyzing chamber 400 is to be formed between the backward flowing portion 120 and the second forward flowing portion 130. That is, two electrolyzing chambers 200, 400 can be provided.

Electrodes are also installed in the second electrolyzing chamber 400, and preferably, the electrodes 300 installed in the electrolyzing chamber 200 extend into the second electrolyzing chamber 400.

Same or different kind of electrolyte can be used to be injected into the two electrolyzing chambers 200, 400. For example, if weak hydrochloric acid is injected in the electrolyzing chamber 200, hydrogen peroxide may be injected in the second electrolyzing chamber 400. If hydrogen peroxide is injected in the second electrolyzing chamber 400, the hydrogen peroxide will be electrolyzed to generate water and oxygen, and the oxidizing power of the generated oxygen can sterilize the treated water and the pipe line.

In addition, to enhance the efficiency of electrolysis, the +, − electrodes 300 are installed so that the connecting terminals 310,320 electrically connected with the electrodes are positioned on the opposite side of the electrolyzing chamber 200, 400. In general, the efficiency of the electrolysis is affected by various factors such as current amount, size of electrode. Particularly, the larger the size of electrode is, the higher the efficiency of electrolysis is. But, even though the size of the electrode is large, if the current is not distributed on the surface of the electrode uniformly, then the efficiency of electrolysis reaction in consideration of the surface area of the electrode will be reduced. That is, as the current would flow through the shortest route, if the current is applied on the electrodes, the current will form the route from the adjacent part of the +electrode connecting terminal 310 to the adjacent part of the—electrode connecting terminal 320. That is, the current value on the part far away from the connecting terminal 310, 320 may be relatively low, so electrolyzing reaction cannot be actively carried out. Therefore, the efficiency of the electrolysis reaction may be lowered.

Accordingly, to enhance the efficiency of electrolysis, the current should be distributed on the surface of the electrode uniformly. For this, in this embodiment of the invention, the connecting terminal 310 of the + electrode 300 is installed on the opposite side of the connecting terminal 320 of the − electrode 300. If the connecting terminal 310,320 of the +, − electrodes 300 are installed on the opposite side to each other, the distance of current travel will be same regardless of the current route, so that the current can be applied on the overall surface of the +, − electrodes 300, and the relatively large surface of the electrode can participate to the electrolysis reaction, so the efficiency of the electrolysis will be enhanced.

1. Electrolysis apparatus for water sterilization and pipe cleaning, wherein the apparatus comprises:
a pipe 100 with U or S shape which has a forward flowing portion 110, a backward flowing portion 120 whose base end is connected to the forward flowing portion 110 and whose fore end is positioned separately apart from the forward flowing portion 110 so that the treated water can flow backwardly against the direction of the treated water flowing in the forward flowing portion 110;
an electrolyzing chamber 200 positioned between the forward flowing portion 110 and the backward flowing portion 120 of the pipe 100, and having an electrolyte inlet 210 and an outlet 220 communicating with the forward flowing portion 110 or the backward flowing portion 120 to let the products generated from the electrolysis reaction exhaust into the forward flowing portion 110 or the backward flowing portion 120; and
+, − electrodes 300 installed in the electrolyzing chamber 200.

2. Electrolysis apparatus of claim 1, wherein the +, − electrodes 300 have inserts 302 extending into the forward flowing portion 110 and the backward flowing portion 120.

3. Electrolysis apparatus of claim 1, wherein the + electrode 300 and the − electrode 300 are positioned on the opposite side of the electrolyzing chamber 200,400 respectively.

4. Electrolysis apparatus of claim 1, wherein a second forward flowing portion 130 is connected to the backward flowing portion 120, in which the treated water flow in the same direction with the treated water in the forward flowing portion 110, and a second electrolyzing chamber 400 is provided between the backward flowing portion 120 and the second forward flowing portion 130.

5. Electrolysis apparatus of claim 2, wherein the + electrode 300 and the − electrode 300 are positioned on the opposite side of the electrolyzing chamber 200,400 respectively.

6. Electrolysis apparatus of claim 2, wherein a second forward flowing portion 130 is connected to the backward flowing portion 120, in which the treated water flow in the same direction with the treated water in the forward flowing portion 110, and a second electrolyzing chamber 400 is provided between the backward flowing portion 120 and the second forward flowing portion 130.
